(19) United States
(12) Patent Application Publication
(10) Pub. No.: US 2006/0129804 A1
(43) Pub. Date: Jun. 15, 2006

(54) Message based network configuration of server certificate purchase

(75) Inventors: Lingan Satkunanathan, Kirkland, WA (US); Leszek Mazur, Bellevue, WA (US); Theodore H. Roberts III, Sammamish, WA (US); Kevin T. Damour, Bellevue, WA (US); Scott A. Manchester, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/009,641

(22) Filed: Dec. 10, 2004

(51) Int. Cl. H04L 9/00

(52) U.S. Cl. 713/156; 713/175

(57) ABSTRACT

Systems and methodologies that facilitate obtaining a digital certificate from a Certificate Authority, by using a well defined protocol exchanged between a user machine and the Certificate Authority. The well defined protocol employs; a purchasing component and an update component. Once a user has obtained a domain name, the purchasing component can be used to query the Certificate Authority for terms of the service plans to issue the digital certificate and to programmatically create and transmit a certificate signing request. The purchase component will also allow the signed certificate to be configured on the requesting cluster of machines. The update component can provide a revised and/or updated list of contact information to the Certificate Authority in addition to revoking an existing certificate.

### TECHNICAL FIELD

The subject invention relates generally to server certificates and establishing Internet presence, and more particularly to systems and methods that facilitate purchase, remote configuration and maintenance of a certificate, via a structured messaging format and protocol.

### BACKGROUND OF THE INVENTION

The rapid growth of the Internet and Internet based applications has created a multitude of benefits for businesses, such as ease of marketing and sales to clients. As such, web based interaction is currently in demand by all types of businesses, e.g., various corporations, medical facilities, businesses, the government, industry, and educational facilities to simplify and enhance everyday tasks such as correspondence (e.g., via email, instant messaging), documentation, problem solving, mathematical computation, scheduling, planning, and information gathering, for example.

In such environments, the Domain Name Service (DNS) allows potential clients to key a URL (Uniform Resource Locator) or domain name into the address line of their browser and access a corresponding server/computer of the business. In general, a Domain Name Service (DNS) includes a distributed set of servers primarily used by internet applications to lookup the network address of a given internet server. For example, an internet application that requires looking up a server name initially can send a DNS query to a local Domain Name server (LDNS), which may be located at the same site. The LDNS can also maintain a cache of resource records, for example, mappings between server names and IP addresses. To facilitate mnemonic identification of destination computer systems, a Domain Name Service (DNS) can typically translate a unique textual name for a destination computer system into the IP address for that computer. The textual name is called a “fully qualified domain name.”

An example of a domain name is “www.Microsoft.com”, wherein, “www” indicates the name of a specific computer on the Internet, “Microsoft” indicates an example of a company name and “.com” indicates commercial (as opposed to .gov for government entities, .edu for education entities, .org for non-profit organizations, and the like). Likewise, progressing from right to left, the host name can be structured from general to very specific. For example, “corn” can typically be referred to as a top-level domain name, “Microsoft” is sometimes referred to as a second-level domain name, and “w ww” can designate the server that handles Internet requests, and is sometimes referred to as the host name. This structure allows reuse of names within different hierarchies.

An example of a URL is “http://www.Microsoft.com/1.gif”, where the “http://” indicates the type of protocol and the last field, “.gif”, indicates a file name, but may also be a Web page, executable application, or other computer readable or executable file located at the URL that the user wishes to access.

When the user enters the URL into a browser, the browser can make a determination as to whether it knows the corresponding IP (Internet Protocol) address. For example, a corresponding IP address for “Microsoft.com” may be 207.46.130.108. The browser knows the corresponding IP address if that host name has been visited recently and the address is still in a short-term host name address table in the browser.

At the same time, initiating presence on the Internet can require installation and configuration of both standards based and specialized proprietary software/procedures (e.g., from DNS providers, Certificate Authorities, and the like) that can further complicate matters. A user who wishes to obtain a domain name needs to work through one of several domain name registrars to purchase a domain name. Typically, this involves the right to use a second level name under one or more top level domains for a given duration. The duration can be extended prior to its expiration. In addition to purchasing a name, the user needs to up date the DNS with the information required to access all the Internet facing hosts associated with that domain name. Such information typically maps the IP addresses of each of these computers to their respective fully qualified domain name. This association can be hosted by the user on a computer/server at his/her location or hosted by one of many service providers. Currently there is a disparate collection of configuration tools that thwart users from employing opportunities provided by the Internet to their full potentials. For example, the DNS hosting provider can require the user to be an expert in configuring DNS and to manually provide instructions to configure the domain name. A certificate authority may require software (e.g., certification software) that need to be installed on a computer system prior to publishing an Internet presence.

For businesses to enjoy benefits of a domain name and thereby presence on the Internet, the domain name not only needs to be configured, but also the communication between the cluster of computers providing Internet facing services and the client machines on the Internet need to be secure. For example, information conveyed over a network is susceptible to interception (e.g., eavesdropping) and tampering if the information is transmitted in an unsecured (e.g., unencrypted) manner. As such, confidential information such as credit card numbers, bank account numbers and social security numbers transmitted over an unsecured channel can be viewed and/or copied by malicious parties intending to commit criminal activity and fraud. For example, a malicious party can intercept a credit card number, and then employ the credit card number to unlawfully purchase goods. The credit card holder then incurs the burden of canceling the credit card, securing credit with another credit card company, protecting their credit history, and seeking relief for the illegal purchases. Additionally without a secure infrastructure a malicious user can impersonate a well known entity, such as a business, to collect sensitive data from the users on the Internet. A consumer experiencing the foregoing can be inclined to avoid employing web-based means when engaging in subsequent purchases. Even the potential for the foregoing can prejudice a user from purchasing and communicating via the web or have a domain name.

In response to security concerns and the increased reliance on web technology in the exchange of information, research, development and implementation efforts have ensued to provide web security mechanisms. For example, authenticating technologies such as Transport Layer Security (TLS) encryption have been developed, and are typically employed and associated with web site to determine whether a website is valid (i.e., trusted). Such technologies can verify a web site via ensuring the website is associated with a valid (e.g., signed) web site certificate. Generally, the web site certificate can provide web site identification such as the web site's publisher, and can be employed to match a web site publisher with the certificate. When a match is successful, the web client is typically provided access to the web site. Similarly, when a match is unsuccessful, the web client is commonly provided with a notification indicating that the web site is not trusted.

A software certificate is used to authoritatively identify an entity such as a cluster of computers or business on the Internet. This is similar to how a photo ID is used to identify a person. A photo ID contains information such as the photograph of the person, name, address, date of birth that help identify an individual. In addition, PhotoIDs have an expiration date. PhotoID are also issued for specific uses such as traveling (Passport document) and driving (drivers license). Similarly a certificate contains information that helps to identify the entity it represents, is issued for specific uses and has a specific expiration date. In order to be trusted by everyone a photo ID needs to be issued by an authority recognized in the intended domain of use. Like wise a certificate needs to be issued by a globally trusted Certificate Authority. This authority has the power to revoke the certificate at any time. As soon as a certificate is revoked it looses its validity.

Currently, publishing a web site on the Internet and employing a certificate can comprise several manual steps that can be time consuming and expensive. For example, configuring a web site to employ TLS encryption typically includes purchasing a certificate from a third party or generating a self-signed certificate, manually installing and manually configuring the certificate on the web server, manually installing and manually configuring the certificate on the web client, and manually trusting the certificate on the web clients local to the server domain. The configuration of the web clients becomes extremely challenging when a self-signed certificate is used. A self-signed certificate is one that is created by a specific entity and is not a globally trusted Certificate Authority. In this case some other mechanism is used to validate the certificate. Currently there are a number of globally trusted certificate providers each of whom has a unique way of delivering a trusted certificate. Both the domain name and certificate purchase and configuration require manual steps today and as a result involve large delays.

Thus and as explained above, users wishing to enjoy presence of their domain names on the Internet are typically subjected to: non-uniform presentations in a multi-vendor environment, cumbersome contacting and installation requirements, waiting periods for appropriate access software and/or hardware to be delivered or installed.

Therefore, there is a need to overcome the aforementioned exemplary deficiencies associated with conventional devices.

### SUMMARY OF THE INVENTION

The following presents a simplified summary of the invention in order to provide a basic understanding of one or more aspects of the invention. This summary is not an extensive overview of the invention. It is intended to neither identify key or critical elements of the invention nor to delineate the scope of the subject invention. Rather, the sole purpose of this summary is to present some concepts of the invention in a simplified form as a prelude to the more detailed description that is presented hereinafter.

The subject invention provides for systems and methods that facilitate server certificate purchase and configuration for presence of services/sites on the Internet, by using a schema that operates between an end user machine and a Certificate Authority (CA), wherein the schema employs; a purchasing component and an update component. The purchasing component can further include various sub components that characterize the Certificate Authority offered term of sale for issuing digital certificates used to create digital signatures such as; requesting platform type, billing, plan selection, renewal, promotional calls, and the like. Similarly, the update component can supply updates for the initial certificate, and to reflect revised data associated with the user, for example, changing the contact information for the owner of the certificate, address/name of the hosting server, type of service (e.g., so that the certificate is not only valid for web presence, but also for secure e-mail), revoke an existing certificate and the like. As such, the role of the Certificate Authority is typically to guarantee that the end user machine granted the unique certificate is, in fact, what it claims to be to its clients.

In accordance with an aspect of the subject invention, a plurality of third party Certificate Authorities can register and receive a standardized set of messages for issuing a digital certificate(s) to a user. Such standard messages can provide a user with a uniform presentation of various plans offered by the plurality of Certificate Authorities, wherein the user can then select a desired plan therefrom for obtaining a digital certificate. The standardized messages can be for example in a form of XML (Extensible Markup Language).

The invention thus facilitates initial server configurations (e.g., presence of small businesses on the Internet), and on-going maintenance, wherein employing multi vendor components are simplified by using a unified and common message structure. Such unified and common message structure can be used by a plurality of end user networked devices such as stand alone routers, window servers, and the like, when interacting with third party Certificate Authorities.

According to a methodology of the subject invention, once a user has selected a domain name and a Domain Name Service (DNS) provider, the purchasing component can automatically query Certificate Authorities for terms of the service to issue digital certificates, which for example can attest that the public key contained in the certificate belongs to the ‘owner’ noted in the certificate. The terms can include; duration for attesting to the digital signature, price, terms of payments and the like. Subsequently, a response to such query can be received by the end user machine. A billing query can then be automatically prepared and submitted to the Certificate Authority. Next, the Certificate Authority can provide a billing response that outlines the service agreement terms for issuing a digital signature for the domain name. The received response can then be displayed to a user, via a uniform presentation such that a user enjoys a similar experience, regardless of which Certificate Authority the user interacts with. The user can then elect a desired plan to initiate internet presence.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 illustrates a schematic block diagram of components associated with a messaging schema exchanged between an end user machine and a Certificate Authority (CA), in accordance with an aspect of the subject invention.

FIG. 2 illustrates a schematic diagram of providing an end user presence on the Internet via employing a multi vendor component, in accordance with an aspect of the subject invention.

FIG. 3 illustrates a plurality of sub components associated with the purchasing component in accordance with an aspect of the subject invention.

FIG. 4 illustrates a sequence of query steps performed between the end user machine and the Certificate Authority in accordance with an aspect of the subject invention.

FIG. 5 illustrates an end user device that connects to the Certificate Authority in accordance with an aspect of the subject invention.

FIG. 6 illustrates a methodology of obtaining a digital certificate from a Certificate Authority that is registered to receive the standardized set of messages in accordance with an aspect of the subject invention.

FIG. 7 illustrates an exemplary graphical uniform interface employed for presentation of various plans offered by the plurality of Certificate Authorities in accordance with an aspect of the subject invention.

FIG. 8 illustrates an update component according to one aspect of the subject invention.

FIG. 9 is a schematic block diagram illustrating a suitable computing environment that can employ various aspects of the subject invention.

FIG. 10 illustrates a user—Certificate Authority interaction that can employ a messaging schema according to one aspect of the subject invention.

Appendix A presented infra provides one particular exemplary set of schema in accordance with an aspect of the subject invention—this appendix is to be considered part of this specification describing the invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component,” “handler,” “model,” “system,” and the like are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal).

The subject invention provides for a standardized messaging schema that facilitates purchase, remote configuration, maintenance and revocation of a certificate, by using a unified message protocol, which is exchanged between a user and a Certificate Authority(ies). The standardized schema employs; a purchasing component, and an update component. Such a messaging schema can further provide for a uniform presentation of various hosting plans offered by the plurality of Certificate Authorities, and thus a user can enjoy a similar experience, regardless of which Certificate Authority the user interacts with.

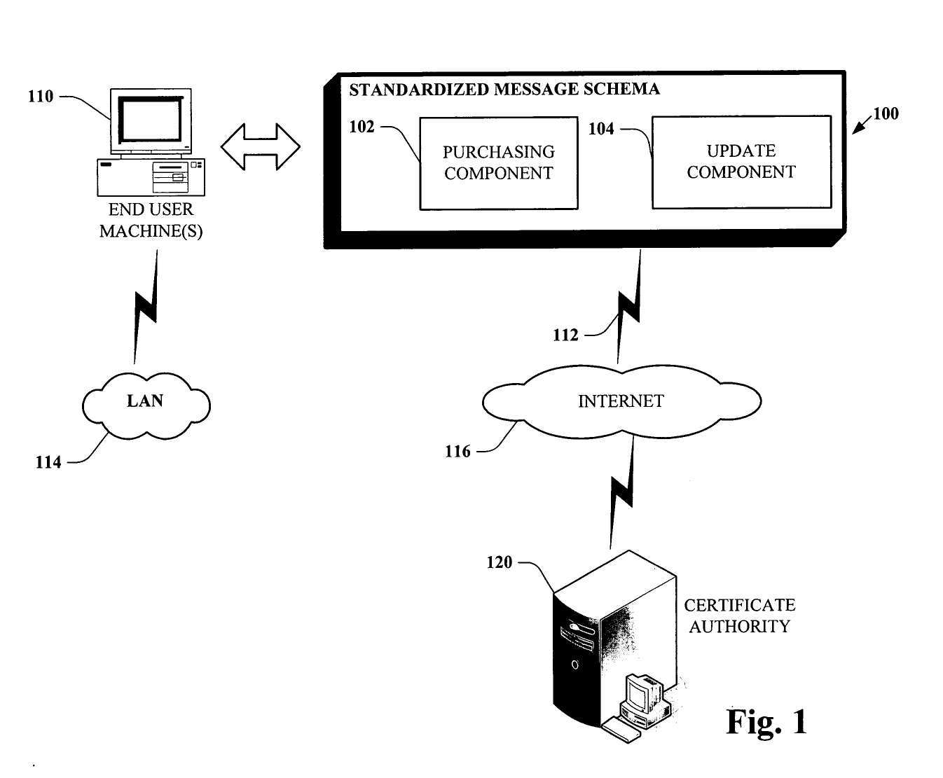

Referring initially to FIG. 1, a block diagram of a messaging protocol 100 for interaction between an end user machine 110 and Certificate Authority(ies) 120 is illustrated. Such messaging protocol 100 can include a purchasing component 102 and an update component 104, which are part of a standardized set of messages exchanged between the end user machine 110 and the Certificate Authority 120.

The end user machine 110 can be a cluster of computers, servers, personal computers, work stations, personal digital assistant, and the like. In addition, the end user machine 110 can also be an Internet Connection Sharing Device (ICSD) that facilitates sharing a connection 112 from a network 114 to the Internet 116. As such, the end user machine 110 can be a computer executing a process that facilitates time-sharing of the Internet connection 112, for example. The connection 112 can be, for example, a modem connection, a DSL connection and/or a wireless connection. The network 114 can be, for example, an Ethernet LAN, a token ring LAN, or other LAN. Although the invention is primarily described within the context of an end user machine 110 that communicates with a Certificate Authority 120, it is to be appreciated that the network 114 can also include a Wide Area Network (WAN). Moreover, the network 114 can include hardwired and/or optical and/or wireless connection paths. The connection 112 can be shared among a plurality of devices connected to the network 114. Such devices can include, personal computers, workstations, televisions and telephones, for example. Sharing of the connection 112 facilitates reducing the cost of one or more of the LAN devices, and can reduce the complexity of managing the network 114 and optimizes the throughput of the connection 112.

Likewise, the Certificate Authority 120 can issue and manage security credentials and public/private key pairs for identification and message encryption. In a related aspect, as part of a public key infrastructure, the Certificate Authority can check with a registration authority (not shown) to verify information provided by the requestor of a digital certificate. If the registration authority verifies the requestor's information, the Certificate Authority can then issue a certificate. The certificate can include the owner's public key, the expiration date of the certificate, the owner's name, and other information about the public key owner.

Once the Certificate Authority registers to receive the standardized messages of the subject invention, a user can select such authority to offer plans for issuing a digital signature for the domain name selected earlier by the user. Each plan can have a plurality of terms and conditions such as, duration, price and the like associated therewith. Upon selection of a plan by the user, the digital certificate can be issued.

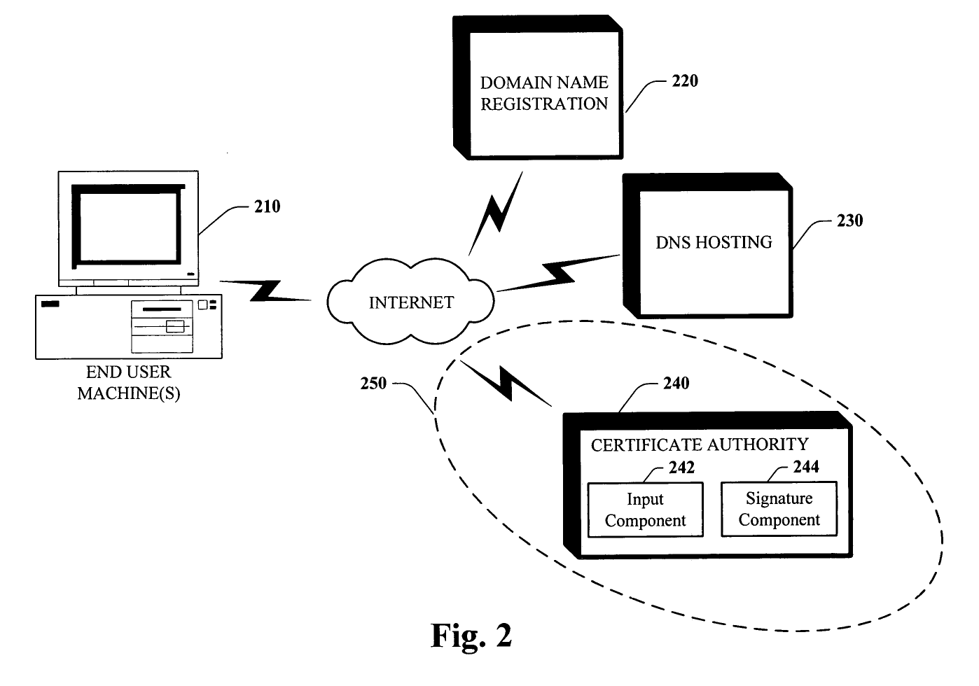

FIG. 2 illustrates a schematic diagram of providing an end user presence on the Internet via employing a multi vendor component, wherein the subject invention primarily addresses the interaction 250 between an end user machine, such as a machine 210 (e.g., small business computer) and a Certificate Authority 240. The end user machine 210 can interact with a plurality of vendors 220, 230, and 240 via the internet. Vendor 220 can primarily supply the end user with a domain name such as “mybusiness.com.”, and manages the various aspects of domain name registration. Upon obtaining such domain name, the end user can then seek and interact with various DNS providers 230 for hosting such domain name.

Similarly, vendor 240 can manage certificate authority and authenticating technologies, such as Transport Layer Security(TLS) encryption with the domain name web site to verify validity (i.e., the website is trusted), as illustrated by the interaction at 250. Such technologies can verify a web site via ensuring the website is associated with a valid (e.g., signed) web site certificate. Generally, the web site certificate can provide web site identification, such as the web site's publisher, and can be employed to match a web site publisher with the certificate. When a match is successful, a secure communication is created between the web client and the web site/service and the web client displays/confirms the authenticity of the site/service to the end user/application. The Certificate Authority 240 can include an input component 242 and a signature component 244.

The input component 242 of the Certificate Authority 240 can be employed to communicate with the end user machine to service requests such as queries and requests including the certificate signing request (CSR). The Certificate Authorities portion of the purchasing and update components can be part of the input component. The input component can then provide the CSR to the signature component 244 of the Certificate Authority 240. Subsequently, the signature component of the Certificate Authority can validate and provide a signed certificate to the input component to be transmitted to the end user machine. The end user machine can then automatically install the signed certificate to a cluster of computers on at the end user location.

As illustrated in FIG. 2, during the interaction 250 a set of standardized messages, for example in the form of XML messages, are automatically exchanged between the end user machine 210 and the Certificate Authority 240. Such standard messages can provide a user with a uniform presentation of various plans offered by various Certificate Authorities, wherein the user can then select a desired plan therefrom. Accordingly, a user enjoys a similar experience, regardless of which Certificate Authority the user interacts with. The user is also able to choose from a group of Certificate Authorities through the aggregation of offerings from on the end user machine user interface.

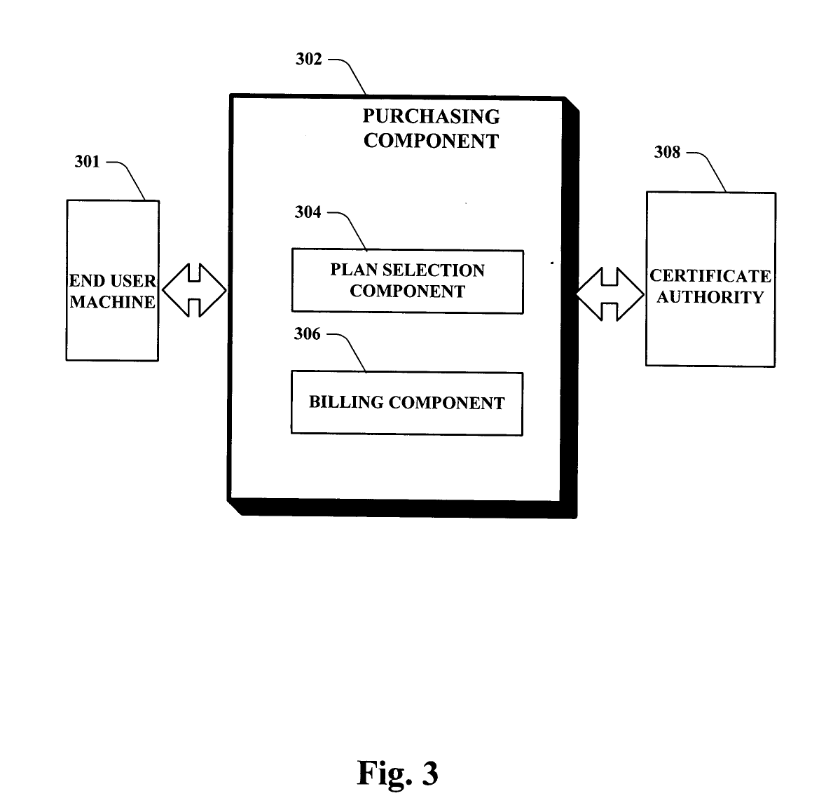

Referring now to FIG. 3 various sub components that can be associated with the purchasing component 302 are illustrated. Such purchasing component 302 can further include a plan selection component 304, and a billing component 306. The purchasing component 302 can query the Certificate Authority 308 for a list of plan offerings and terms of the service agreement that are associated with the plan selection component 304. Such can include: the duration of supplying the digital certificate, identification of the top level domain name (TLD), requesting platform type, intended use, a language hint that designates to the Certificate Authority 308 what language the server can employ, renewal options, promotional calls and the like.

An exemplary schema that can define an expression of shared vocabulary between the end user machine 301 and Certificate Authority 308 is presented at the end of this document, as part of appendix A. Such exemplary schema can for example be in form of an Extensible Markup Language (XML) that can define and describe a class of XML documents using schema constructs of an XML schema language. These schema constructs can be used to constrain and document the meaning, usage, and relationships of data types, elements and their content, attributes and their values, entities, contents and notations, as used in XML documents. Thus, in general any computer system that can access an XML schema can process XML documents in accordance with the XML schema. Furthermore, typically any computer system that can access an XML schema can compose or modify XML documents for use by other computer systems that can also access the XML schema. A schema can be utilized to define virtually any data type including logical, binary, octal, decimal, hexadecimal, integer, floating-point, character, character string, user-defined data types, and combinations of these data types used to defined data structures. XML elements and attributes can be defined to represent data types that are defined by a schema.

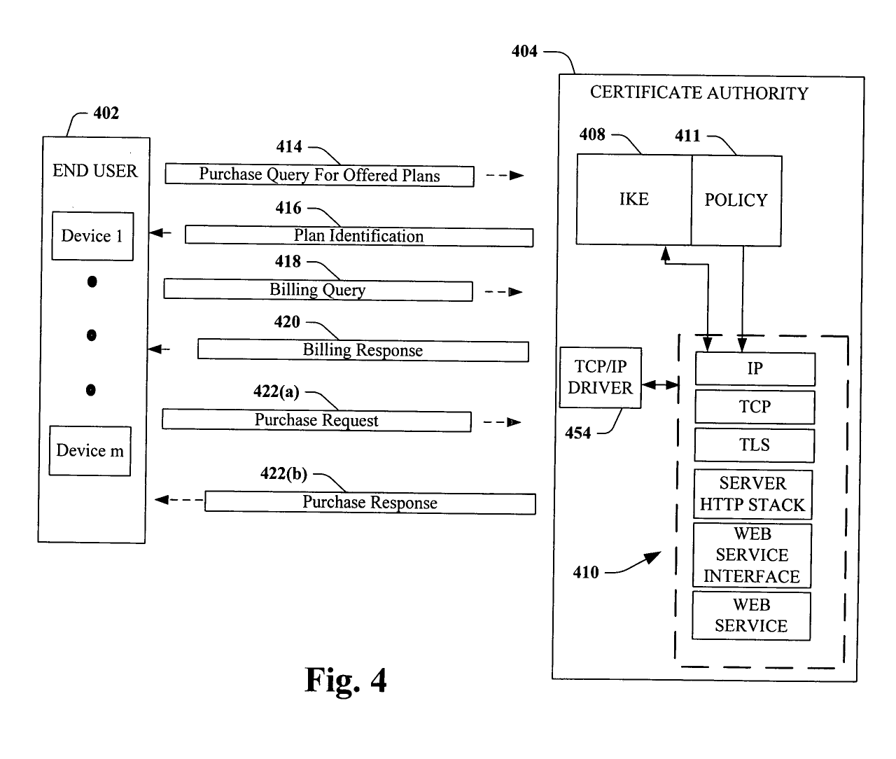

FIG. 4 illustrates a sequence of query steps between end user machines 402 (1 thru m, where m is an integer) and a Certificate Authority 404. The communication itself will be done via a secure channel. The Certificate Authority 404 can include a service side secure network stack 410 that further includes an IP layer implementation, a service side TCP layer implementation, a service side TLS, an HTTP stack implementation, a web service provider interface and a web service. The Certificate Authority 404 can include an Internet Key Exchange (IKE) subsystem 408 for securing network traffic between the Certificate Authority 404 and the end user devices 402. The Certificate Authority 404 can also include policy modules 411 to enable configuration of the IKE subsystems 408. The policy module 411 can also provide security configuration information to the secure network stack 410, which communicate via TCP/IP driver 454, thereby enabling secure network traffic between the Certificate Authority 404 and the end user machines 402.

The Certificate Authority 404 can register and receive the standardized set of messages for issuing a digital certificate to an entity. For example, at 414 the purchasing component of the standardized schema of the subject invention can query the Certificate Authority 404 that is registered for receiving the standardized messages for a purchase query of the various plan offerings. Next, and at 416 a purchase query response identifying the various plans and terms of the service is communicated via the standardized set of messages of the subject invention back to the Certificate Authority 404. Subsequently and at 418, a billing query is transferred to the Certificate Authority 404. A response can then be prepared and sent back to the end user machine at 420 regarding various billing requirements for issuing a digital certificate.

The received response can then be displayed to a user, via a uniform presentation such that a user enjoys a similar experience, regardless of which Certificate Authority the user interacts with. Next, the user can select a desired plan for purchase, with a purchase request/response pair 422(a) & 422 (b) exchanged between the Certificate Authority 404 and the end user machine(s) 402. Likewise, a set of queries and responses (not shown) can be exchanged between the Certificate Authority 404 and the end user machine(s) 402 to request updates of the initial certificate and to reflect revised data associated with the user, for example, changing the contact information for the owner of the certificate, address/name of the hosting server, type of service (e.g., so that the certificate is not only valid for web presence but also for secure e-mail) and the like. Additionally, the certificate itself can be revoked from being used via the update mechanism. The purchase and update components can also include a mechanism for the end user machines to authenticate themselves with the Certificate Authority. An exemplary XML schema for such procedure via the update component, (as well as for the purchasing component described supra) is presented as part of appendix A—infra.

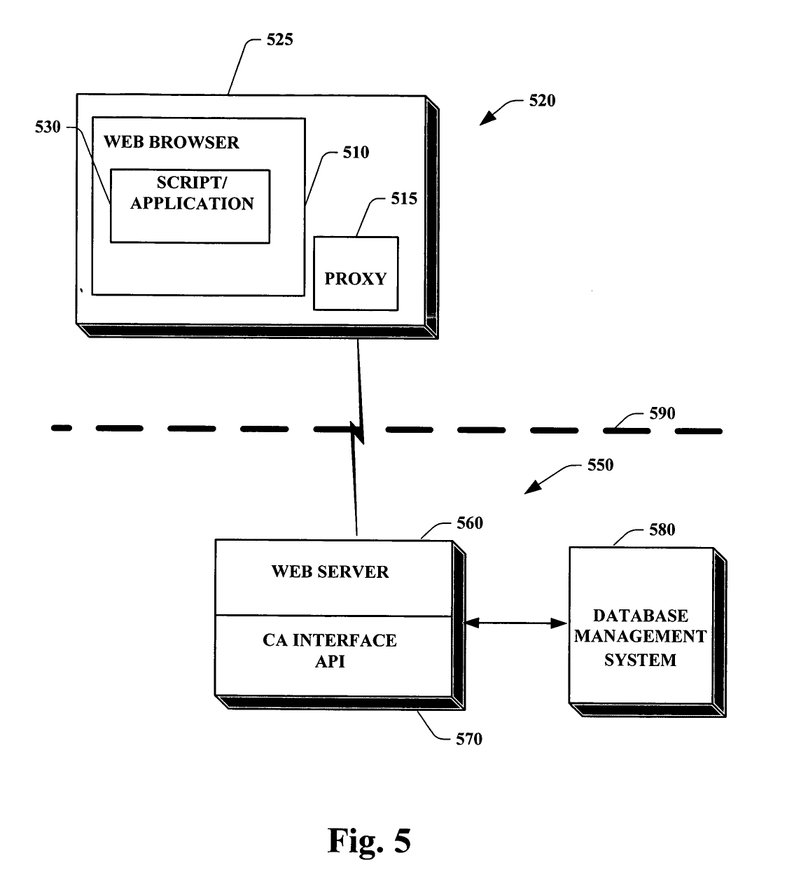

FIG. 5 illustrates an end user device that connects to a Certificate Authority in accordance with an aspect of the subject invention, wherein running on the end user side 520 can be a client process, for example, a web browser 510. Likewise, running on the Certificate Authority side 550 can be a corresponding server process, for example, a web server 560. In addition, embedded in the Web Browser 510 can be a script or application 530, and running within the run-time environment 525 of the end user device 520, can exist a proxy 515 for packaging and unpacking data packets formatted in accordance with the standardized messages of the subject invention. Communicating with the Certificate Authority can be a database management system (DBMS) 580, which manages access to a content database of domain names or registration authority.

The DBMS 580 and the database (not shown) can be located in the Certificate Authority itself, or can be located remotely on a remote database server (not shown). Running on the Web server 560 can be a Certificate Authority (CA) interface Applications Programming Interface (API) 570, which provides access to the DBMS 580. The end user device 520 and the Certificate Authority 550 can communicate with each other through a network 590, (e.g., the Internet). When the client process, e.g., the Web browser 510, requests a query of service plans from the Certificate Authority, the script or application 530 can issue a query, which is sent across the network (e.g., Internet) 590 to Certificate Authority side 550, where it is interpreted, by the Web server 560. The end user's 520 request to the Certificate Authority side 550 can contain multiple commands, and a response from the Certificate Authority 550 can return a plurality of service plan options. The received response can then be displayed to a user, via a uniform presentation such that a user enjoys a similar experience, regardless of which Certificate Authority the user interacts with. The invention thus facilitates initial server configurations (e.g., presence of small businesses on the Internet), and on-going maintenance, wherein employing multi vendor components are simplified by using a unified and common message structure.

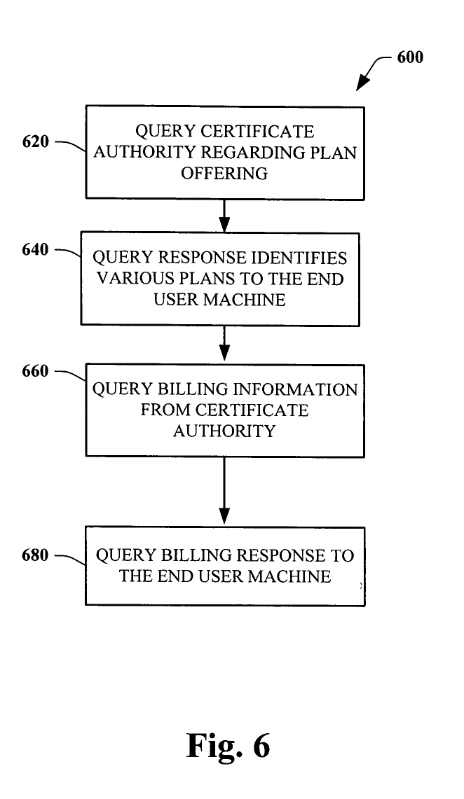

FIG. 6 illustrates a methodology 600 of issuing a certificate by the Certificate Authority registered to receive standardized set of messages, in accordance with an aspect of the subject invention. Initially, and at 620 the purchasing component, as part of the standardized message schema of the subject invention, can query the Certificate Authority(ies) regarding the various plan offerings. In response to such query, and at 640 a purchase query response (e.g., data packets) identifying the various plans and terms of the service is communicated via the standardized set of messages of the subject invention back to the end user machine. Subsequently and at 660, a billing query is transferred to the Certificate Authority. A response can then be prepared and sent back to the end user machine regarding various billing requirements for issuing the certificate, at 680. The received response can then be displayed to a user, via a uniform presentation such that a user enjoys a similar experience, regardless of which Certificate Authority the user interacts with. The user can then select a desired plan for purchase, and initiate secure presence of its domain name on the web.

While the exemplary method is illustrated and described herein as a series of blocks representative of various events and/or acts, the present invention is not limited by the illustrated ordering of such blocks. For instance, some acts or events may occur in different order and/or concurrently with other acts or events, apart from the ordering illustrated herein, in accordance with the invention. In addition, not all illustrated blocks, events or acts, may be required to implement a methodology in accordance with the present invention. Moreover, it will be appreciated that the exemplary method and other methods according to the invention may be implemented in association with the method illustrated and described herein, as well as in association with other systems and apparatus not illustrated or described.

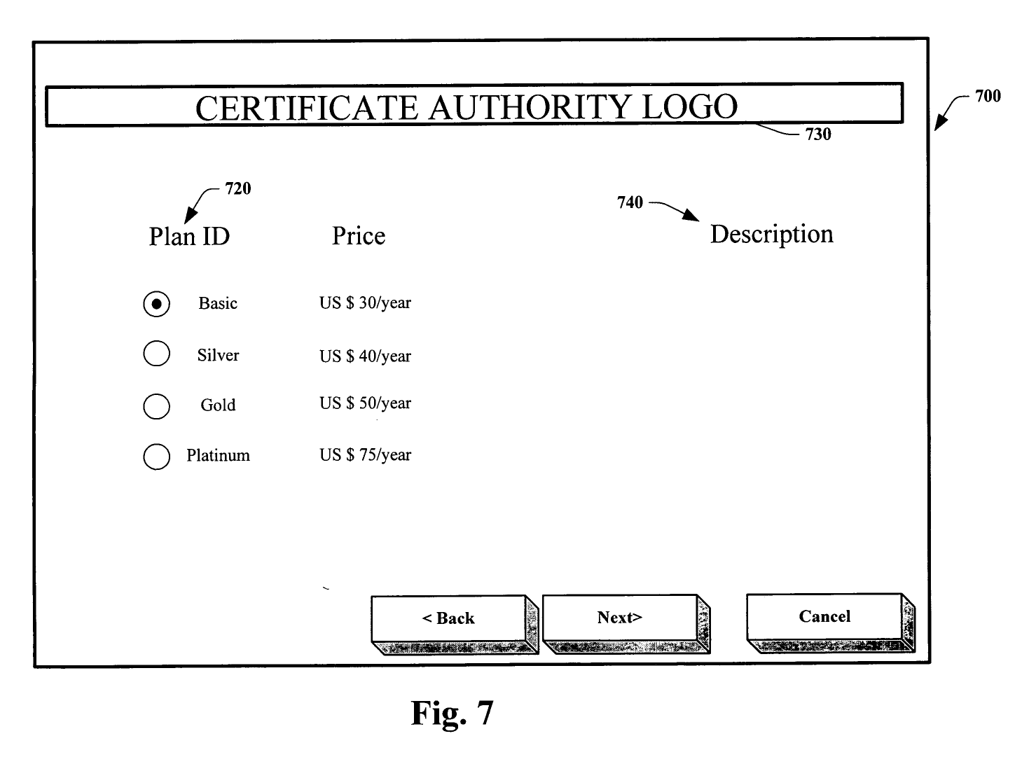

FIG. 7 illustrates an exemplary graphical uniform interface employed for presentation of various plans offered by the plurality of the Certificate Authority(ies), wherein the user can then select a desired plan therefrom. Such graphical interface 700 displays returned results, and can provide a user with a uniform configuration tool for internet presence. The exemplary user interface (GUI) 700 of the subject invention can be employed to facilitate account generation for issuing digital certificates. Such GUI 700 comprises a identification region 720 for the various plans offered by a Certificate Authority. In addition, a space 730 can be reserved on the GUI 700 to display a logo associated with the Certificate Authority, with a description section 740 describing the nature of the plans offered. As such, a user can benefit from a similar experience regardless of which Certificate Authority the user interacts with. The user can then select a desired plan for purchase.

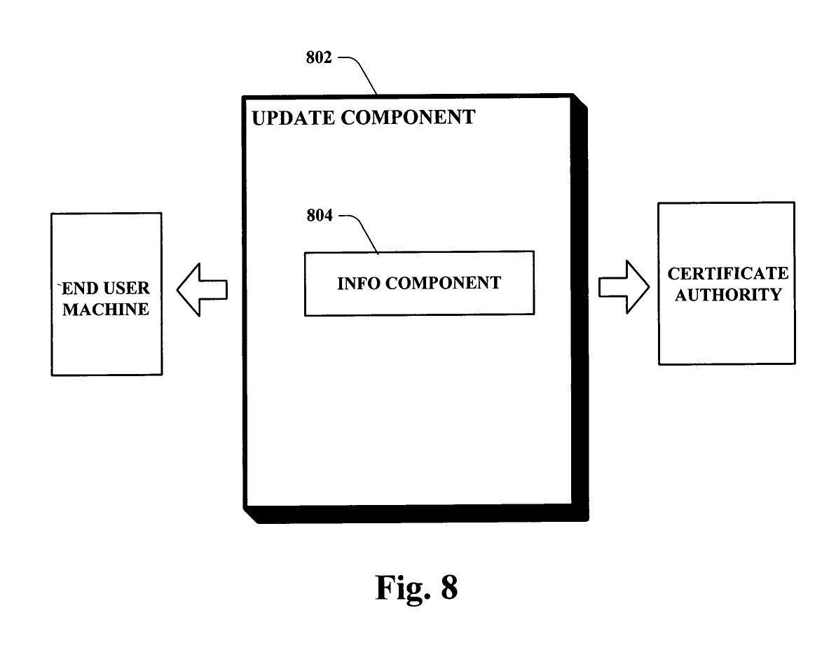

FIG. 8 illustrates an update component according to one aspect of the subject invention. The update component can provide a revised and/or updated list of contact information to the Certificate Authority. Such update component can further incorporate an info component 804, which includes for example, an updated administrative contact, technical contact, contact in case of host server failure, and the like. Also, additional fields can be defined in the schema of the subject invention for authorization for a transfer of the digital certificate to another party. The update component can also include a mechanism to revoke an valid certificate.

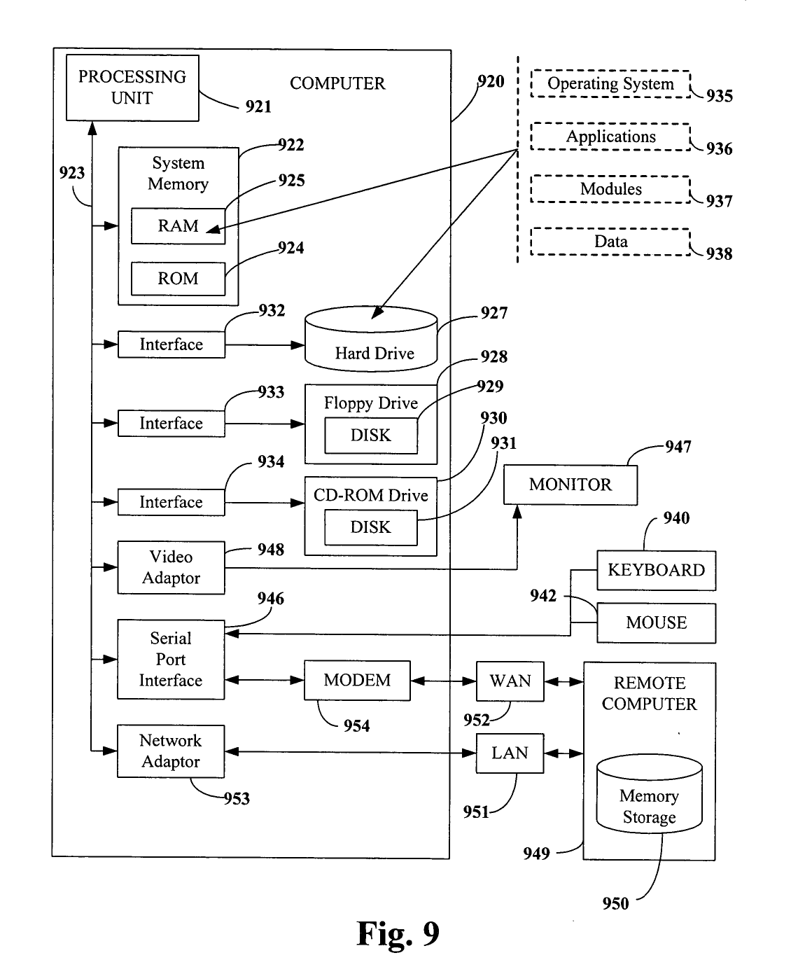

Referring now to FIG. 9, a brief, general description of a suitable computing environment on the client as well as the server side is illustrated wherein the various aspects of the subject invention can be implemented. While the invention has been described above in the general context of computer-executable instructions of a computer program that run on a computer and/or computers, those skilled in the art will recognize that the invention can also be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like. As explained earlier, the illustrated aspects of the invention can also be practiced in distributed computing environments where tasks are performed by remote processing devices that are linked through a communications network. However, some, if not all aspects of the invention can be practiced on stand-alone computers. In a distributed computing environment, program modules can be located in both local and remote memory storage devices. The exemplary environment includes a computer 920, including a processing unit 921, a system memory 922, and a system bus 923 that couples various system components including the system memory to the processing unit 921. The processing unit 921 can be any of various commercially available processors. Dual microprocessors and other multi-processor architectures also can be used as the processing unit 921.

The system bus can be any of several types of bus structure including a memory bus or memory controller, a peripheral bus, and a local bus using any of a variety of commercially available bus architectures. The system memory may include read only memory (ROM) 924 and random access memory (RAM) 925. A basic input/output system (BIOS), containing the basic routines that help to transfer information between elements within the computer 920, such as during start-up, is stored in ROM 924.

The computer 920 further includes a hard disk drive 927, a magnetic disk drive 928, e.g., to read from or write to a removable disk 929, and an optical disk drive 930, e.g., for reading from or writing to a CD-ROM disk 931 or to read from or write to other optical media. The hard disk drive 927, magnetic disk drive 928, and optical disk drive 930 are connected to the system bus 923 by a hard disk drive interface 932, a magnetic disk drive interface 933, and an optical drive interface 934, respectively. The drives and their associated computer-readable media provide nonvolatile storage of data, data structures, computer-executable instructions, etc. for the computer 920. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment, and further that any such media may contain computer-executable instructions for performing the methods of the subject invention.

A number of program modules can be stored in the drives and RAM 925, including an operating system 935, one or more application programs 936, other program modules 937, and program data 938. The operating system 935 in the illustrated computer can be substantially any commercially available operating system.

A user can enter commands and information into the computer 920 through a keyboard 940 and a pointing device, such as a mouse 942. Other input devices (not shown) can include a microphone, a joystick, a game pad, a satellite dish, a scanner, or the like. These and other input devices are often connected to the processing unit 921 through a serial port interface 946 that is coupled to the system bus, but may be connected by other interfaces, such as a parallel port, a game port, a universal serial bus (USB) or a 1394 firewire. A monitor 947 or other type of display device is also connected to the system bus 923 via an interface, such as a video adapter 948. In addition to the monitor, computers typically include other peripheral output devices (not shown), such as speakers and printers.

The computer 920 can operate in a networked environment using logical connections to one or more remote computers, such as a remote computer 949. The remote computer 949 may be a workstation, a server computer, a router, a peer device or other common network node, and typically includes many or all of the elements described relative to the computer 920, although only a memory storage device 950 is illustrated in FIG. 9. The logical connections depicted in FIG. 9 may include a local area network (LAN) 951 and a wide area network (WAN) 952. Such networking environments are commonplace in offices, enterprise-wide computer networks, intranets and the Internet.

When employed in a LAN networking environment, the computer 920 can be connected to the local network 951 through a network interface or adapter 953. When utilized in a WAN networking environment, the computer 920 generally can include a modem 954, and/or is connected to a communications server on the LAN, and/or has other means for establishing communications over the wide area network 952, such as the Internet. The modem 954, which can be internal or external, can be connected to the system bus 923 via the serial port interface 946. In a networked environment, program modules depicted relative to the computer 920, or portions thereof, can be stored in the remote memory storage device. It will be appreciated that the network connections shown are exemplary, and other means of establishing a communications link between the computers can be employed.

In accordance with the practices of persons skilled in the art of computer programming, the subject invention has been described with reference to acts and symbolic representations of operations that are performed by a computer, such as the computer 920, unless otherwise indicated. Such acts and operations are sometimes referred to as being computer-executed. It will be appreciated that the acts and symbolically represented operations include the manipulation by the processing unit 921 of electrical signals representing data bits which causes a resulting transformation or reduction of the electrical signal representation, and the maintenance of data bits at memory locations in the memory system (including the system memory 922, hard drive 927, floppy disks 928, and CD-ROM 931) to thereby reconfigure or otherwise alter the computer system's operation, as well as other processing of signals. The memory locations wherein such data bits are maintained are physical locations that have particular electrical, magnetic, or optical properties corresponding to the data bits.

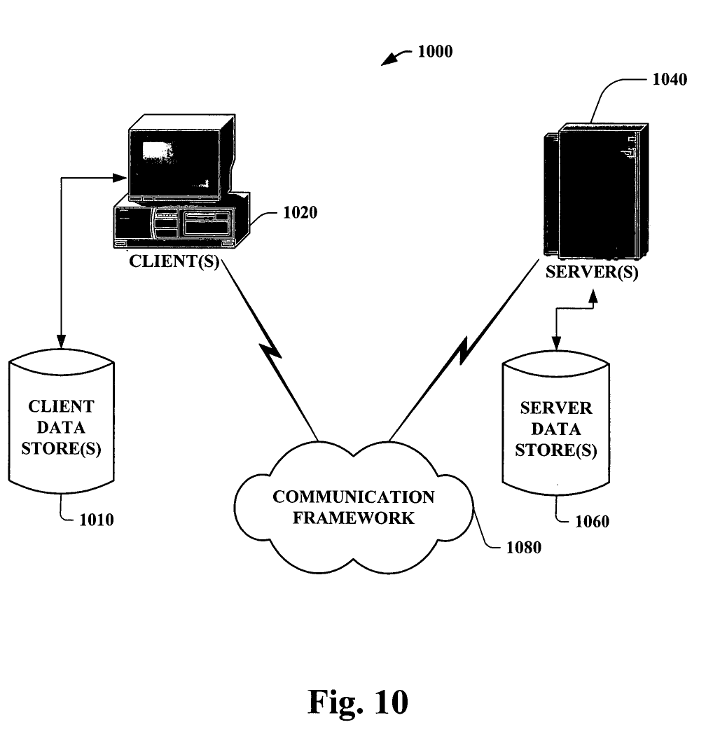

Referring now to FIG. 10, a user—Certificate Authority interaction system 1000 that employs a standardized schema according to one aspect of the subject invention is illustrated. The client(s) 1020 can be hardware and/or software (e.g., threads, processes, computing devices). The system 1000 also includes one or more server(s) 1040. The server(s) 1040 can also be hardware and/or software (e.g., threads, processes, computing devices). For example, such servers 1040 can house threads to perform transformations by employing the subject invention. The client 1020 and the server 1040 can communicate, in the form of data packets transmitted according to the subject invention, between two or more computer processes. The client/server can also share the same process. As illustrated, the system 1000 includes a communication framework 1080 that can facilitate communications between the client(s) 1020 and the server(s) 1040. The client(s) 1020 is operationally connected to one or more client data store(s) 1010 that can store information local to the client(s) 1020. Moreover, client 1020 can access and update databases 1060 located on a server computer 1040 running a server process. In one aspect of the subject invention, the communication framework 1080 can be the Internet, with the client process being a Web browser and the server process being a Web server. As such, a typical client 1020 can be a general purpose computer, such as a conventional personal computer having central processing unit (CPU), system memory, modem or network card for connecting the personal computer to the Internet, and a display as well as other components such as a keyboard, mouse, and the like. Likewise a typical server 1040 can be university or corporate mainframe computers, or dedicated workstations, and the like.

A sample XML schema that provides an example for the various components according to the subject invention is provided infra, as part of appendix A, and this appendix is to be considered part of this specification describing the invention.

Moreover, although the invention has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention. Furthermore, to the extent that the terms “includes”, “including”, “has”, “having”, and variants thereof are used in either the detailed description or the claims, these terms are intended to be inclusive in a manner similar to the term “comprising.”

What is claimed is:

1. A system that facilitates a user interaction with a Certificate Authority (CA) comprising:
a standardized message schema exchanged between the Certificate Authority and a machine of the user, the schema comprising:
a purchasing component that characterizes a service agreement for a certificate issued by the Certificate Authority; and
an update component that updates the certificate to reflect revised data associated with the user.

2. The system of claim 1, the standardized message schema is in a form of a mark up language.

3. The system of claim 1, the standardized message schema provides the user with a uniform presentation of plans when interacting with a plurality of Certificate Authorities.

4. The system of claim 1, the certificate attests that a public key contained in the certificate belongs to an owner noted in the certificate.

5. The system of claim 1, the purchasing component characterizes at least one of a plan selection, renewal option, promotional call and a billing plan.

6. The system of claim 1, the Certificate Authority employs a TLS encryption technology.

7. The system of claim 1, the Certificate Authority matches a cluster of computers on the Internet with a certificate.

8. The system of claim 1, the machine of the user and the Certificate Authority communicate over the Internet.

9. The system of claim 8, the machine of the user is at least one of a personal computer, workstation, server and an internet connection sharing device.

10. The system of claim 1, the Certificate Authority comprises an input component and a signature component.

11. The system of claim 10, the input component is part of an interface that interacts with the end user components.

12. A method of facilitating selection of a Certificate Authority to issue a digital certificate for a user comprising:
automatically querying the Certificate Authority for terms of service via a purchasing component of a standardized message schema that is exchanged between the Certificate Authority and a user machine.

13. The method of claim 12 further comprising updating or revoking the digital certificate via an update component of the standardized message schema to reflect revised data associated with the user.

14. The method of claim 12 further comprising receiving a response by the user machine for plans offered by the Certificate Authority.

15. The method of claim 12 further comprising employing an XML as part of the standardized message schema.

16. The method of claim 12 further comprising receiving a user input for selection of an offered plan.

17. A computer readable medium having stored thereon computer executable instructions for carrying out the method of claim 12.

18. The method of claim 12 further comprising sending a billing query to the Certificate Authority.

19. The method of claim 12 further comprising receiving a response to the billing query by the user machine.

20. The method of claim 19 further comprising displaying terms of the service agreement to the user in a uniform format.

21. A computer-readable medium having stored thereon a data structure comprising:
a computer executable component that characterizes a service agreement of a Certificate Authority for issuance of a certificate, as part of a standardized message schema exchanged between the Certificate Authority and a computer of an end user; and
a further computer executable component that updates the certificate, to reflect revised data associated with the end user.

22. The computer-readable medium of claim 21, the Certificate Authority attests that a public key contained in the certificate belongs to an owner noted in the certificate.

23. The computer-readable medium of claim 21, the Certificate Authority employs an encryption mechanism such as TLS.

24. The computer-readable medium of claim 21, a received response by the computer from the Certificate Authority is displayed to an end user via a uniform presentation such that the user enjoys a similar experience, regardless of the Certificate Authority the user interacts with.

25. The computer-readable medium of claim 21 the standardized messages employ an XML format.

26. A system that facilitates issuing a digital certificate by a Certificate Authority comprising:
means for automatically characterizing terms of sale for a digital certificate between a Certificate Authority and an end user computer;
means of programmatically accepting a certificate signing request (CSR), validating it and providing a signed certificate or status of the transaction and
means for updating the digital certificate to reflect revised data associated with the end user.

27. The system of claim 26 further comprising graphic interface means for providing a uniform experience regardless of which Certificate Authority the user selects to interact with.

28. The system of claim 27 the graphic interface means comprises a description space for describing terms of service.

29. The system of claim 26 further comprising means for transferring the digital certificate to another party.
